(19) United States
(12) Patent Application Publication
(10) Pub. No.: US 2005/0003892 A1
(43) Pub. Date: Jan. 6, 2005

(54) [SOUND DEVICE OF VIDEO GAME SYSTEM]

(75) Inventors: Ming-Kuo Cheng, TAIPEI (TW); Chiu-Hao Cheng, TAIPEI (TW); Chi-Fu Peng, TAIPEI (TW)

Correspondence Address: ZEROPLUS TECHNOLOGY CO., LTD., 2F-4, NO. 184, SEC. 4, CHUNG HSIAO EAST ROAD, TAIPEI, TW

(73) Assignees: ZEROPLUS TECHNOLOGY CO., LTD., CHUNGHO CITY,TAIPEI HSIEN (TW); VISION ELECTRONICS CO., LTD., CHUNGLI CITY,TAOYUAN HSIEN (TW)

(21) Appl. No.: 10/709,643

(22) Filed: May 19, 2004

(30) Foreign Application Priority Data
Jul. 3, 2003 (TW) 092212278

(51) Int. Cl. A63F 13/00

(52) U.S. Cl. 463/35

(57) ABSTRACT

A sound device of a video game system is provided. The video game system has at least a video game player having a first control circuit and a first communication interface and second communication interface. The sound device has a game controller, a third communication interface and a second control circuit. The game controller is connected to the first communication interface, the third communication interface is connected to the second communication interface and the second control circuit is connected to the third communication interface, a speaker, a microphone, a volume regulator and a microphone switch. A signal generated by operating the volume regulator and the microphone switch can be used by the second control circuit to control a volume of the speaker and to turn on/off the microphone, and players can communicate with each other via the speaker and the microphone without wearing an earphone and microphone while playing online video game.

### CROSS REFERENCE TO RELATED APPLICATIONS

This application claims the priority benefit of Taiwan patent application number 092212278 filed on Jul. 3, 2003.

### BACKGROUND OF INVENTION

1. The Field of the Invention

The present invention relates to a sound device of video game system, and more particularly to a video game system comprising a video game player, a game controller and a sound device connected to the video game player allowing a player to wirelessly control the wireless controller for communicating with other online players via microphone and speaker without wearing the earphone and microphone.

2. Description of Related Art

Presently, the online games are popular. The players can play not only PC games but also the online internet games. Several manufacturers have invested in developing various peripheral products for the video game with a view of achieving user-friendly operations and to provide more convenience to the players. For example, some manufacturers designed using earphone and speaker players to communicate with each other while playing the game in order to create more fun.

Referring to FIGS. 1A, 1B, 1C and 2, elevational views of a conventional video game system, and elevational view of a conventional game controller and a sound adaptor, a headset and a block diagram of a circuit of a sound device, are respectively shown. The peripheral products available for video game player, Xbox of Microsoft, includes a video game player 10A, a game controller 20A, a sound adaptor 30A, and a sound device 40A comprising a earphone 41A and a microphone 42A. The game controller 20A comprises a first memory card slot 22A suitable for receiving the sound adaptor 30A having external card bus to allow communication between the second communication interface 35A and the game controller 20A. The earphone 41A and the microphone 42A can be connected to the sound adaptor 30A via the sound transmission wire 43A and the headset jack 34A. With the above connection, the first control circuit 21A and the first communication interface 25A of the game controller 20A can communicate with the video game player 10A. Furthermore, the game controller 20A comprises the second memory card slot 23A and the buttons 24A. The second memory card slot 23A is a reserved slot and the buttons 24A are adapted for controlling the functions of the game. Additionally, the sound adaptor 30A comprises a second control circuit 31A, a volume regulator 32A and a microphone switch 33A. The second control circuit 31A is adapted for controlling the volume of the earphone 41A and for turning on/off the microphone 42A.

However, the above conventional video game system has the following defects.

1. The specifications of the earphone 41A and the microphone 42A are different from the other available products, therefore, if the earphone 41A and the microphone 42A are damaged, the user must purchase the whole set as a replacement. Thus, the cost is high and thereby discouraging some of the players from buying such video game system.

2. The earphone 41A and the microphone 42A must be connected via sound transmission wire 43A to communicate with the sound adaptor 30A and therefore causing inconvenience to players for controlling the game controller 20A.

3. Because the earphone 41A and the microphone 42A are designed to directly contact player's ear, and the weight of the earphone 41A and the microphone 42A could cause uneasiness to the player after a long time usage.

4. The player cannot move freely due to the wired connection of the sound transmission wire 43 and the controller transmission wire.

Besides, the other available video game player, PS2 of Sony, particularly for playing online game, has built-in control interface of the earphone and the microphone. The disadvantage of this product is that the players cannot move freely due to the sound transmission wire and the controller transmission wire.

### SUMMARY OF INVENTION

Accordingly, in the view of the foregoing, the present inventor makes a detailed study of related art to evaluate and consider, and uses years of accumulated experience in this field, and through several experiments, to create a new sound device of video game system. The present invention provides an innovated cost effective sound device of video game system such that a use can execute a game by controlling the game controller and wirelessly communicate with other users via the game controller within a valid range without wearing wired microphone and speaker.

According to an aspect of the present invention, the video game player is connected to the game controller and the sound device. The sound device comprises a volume regulator and a microphone switch. The volume adjustment signal and turning on/off the microphone signals are adapted for controlling the volume of the speaker and for turning on/off the microphone. The player can communicate with other online player via the built-in speaker and microphone, and therefore the player need not wear the earphone and the microphone while playing the game.

According to another of the present invention, the second control circuit comprises an auto-gain circuit for balancing an over loud volume sound or a low volume sound and an echo canceling circuit for canceling an echo.

### BRIEF DESCRIPTION OF DRAWINGS

For a more complete understanding of the present invention, reference will now be made to the following detailed description of preferred embodiments taken in conjunction with the following accompanying drawings.

FIG. 1A is an elevational view of a conventional video game system.

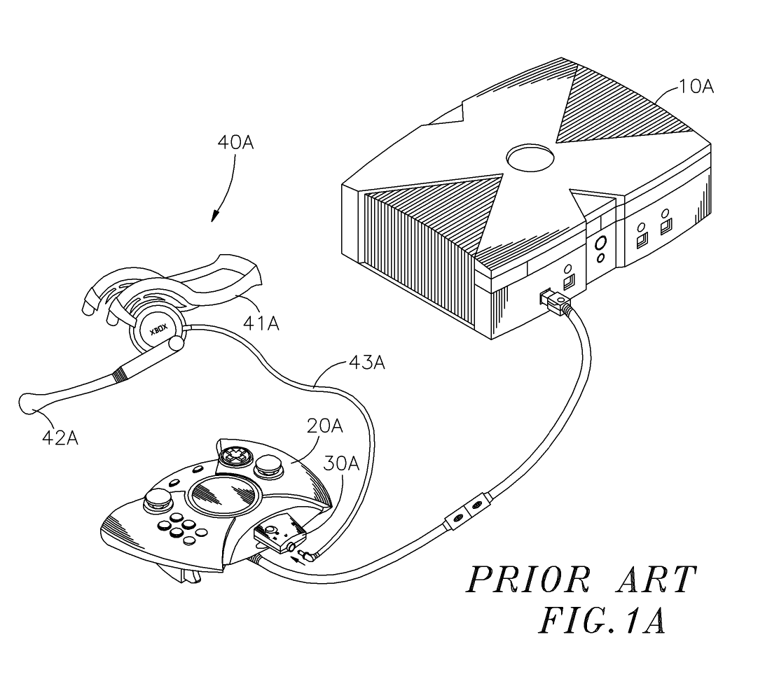

FIG. 1B is an elevational view of a conventional game controller and sound adaptor.

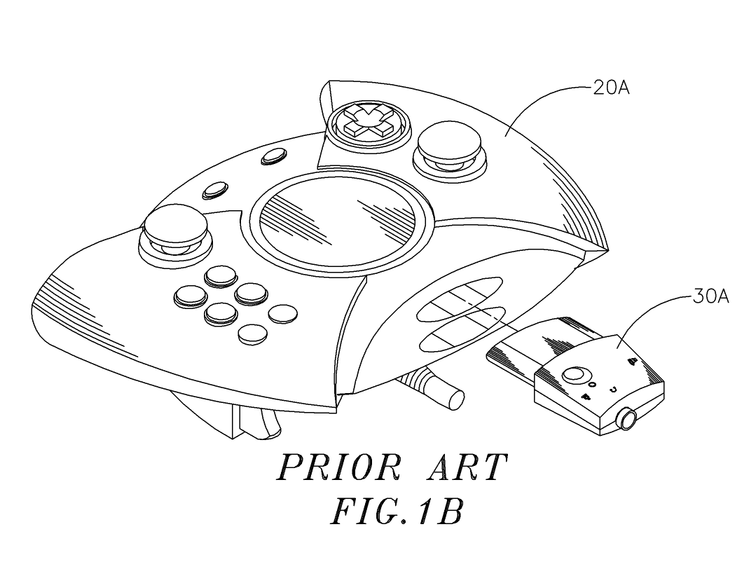

FIG. 1C is an elevational view of a conventional headset.

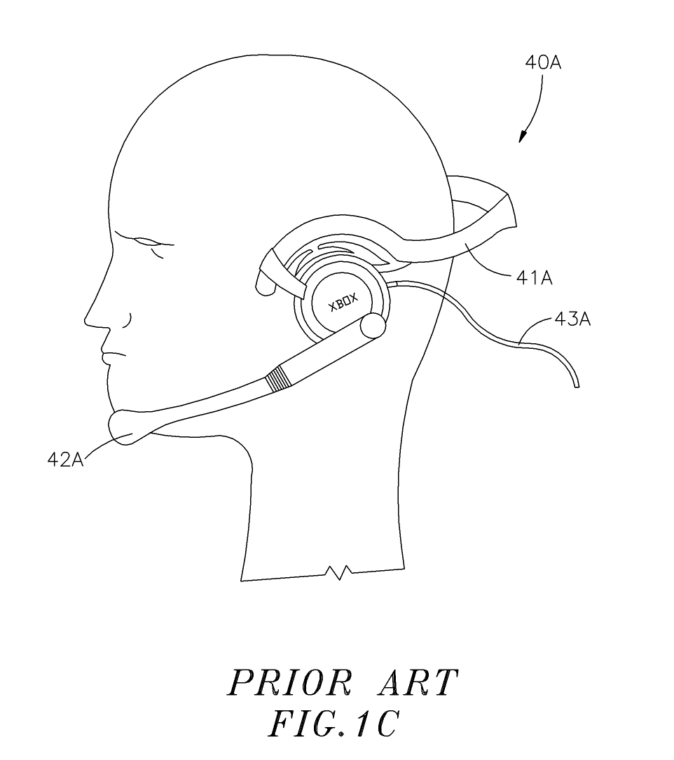

FIG. 2 is a block diagram of a circuit of a conventional video game system.

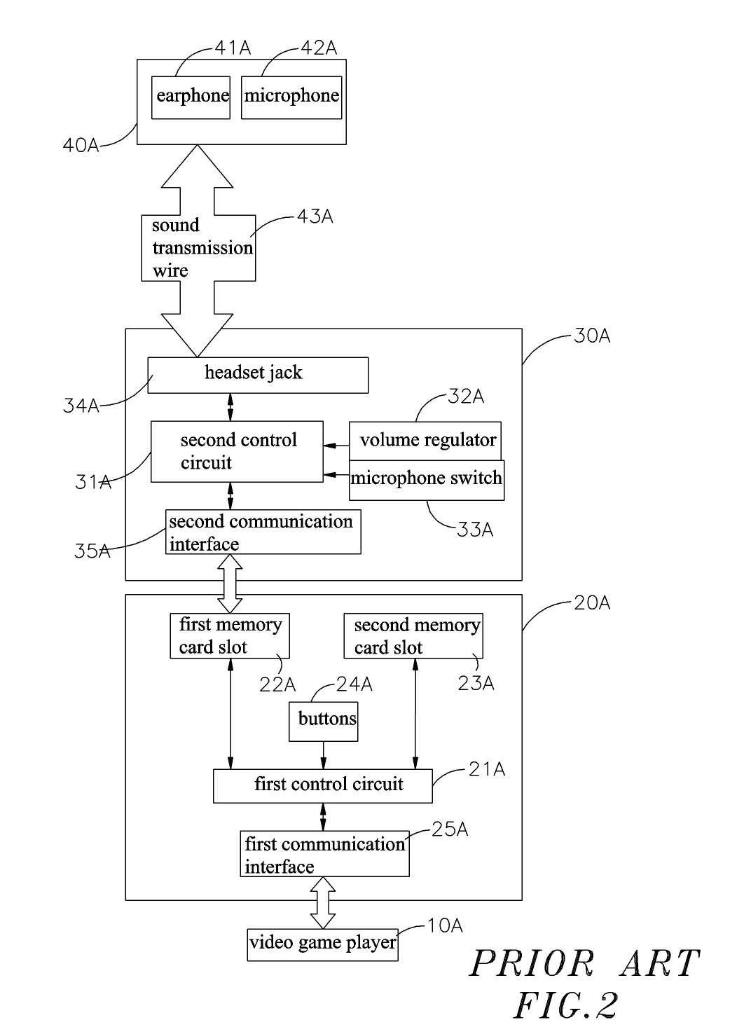

FIG. 3A is the elevational view (1) of a video game system according to an embodiment of the present invention.

FIG. 3B is an elevational view (2) of a video game system according to an embodiment of the present invention.

FIG. 3C is a elevational view (3) of a video game system according to an embodiment of the present invention.

FIG. 3D is an elevational view (4) of a video game system according to an embodiment of the present invention.

FIG. 3E is an elevational view (5) of a video game system according to an embodiment of the present invention.

FIG. 3F is an elevational view (6) of a video game system according to an embodiment of the present invention.

FIG. 4 is a block diagram of a circuit of a video game system according to an embodiment of the present invention.

FIG. 5A is an elevational view (1) of a video game system according to an embodiment of the present invention.

FIG. 5B is an elevational view (2) of a video game system according to an embodiment of the present invention.

FIG. 5C is an elevational view (3) of a video game system according to an embodiment of the present invention.

FIG. 5D is an elevational view (4) of a video game system according to an embodiment of the present invention.

FIG. 5E is an elevational view (5) of a video game system according to an embodiment of the present invention.

FIG. 5F is an elevational view (6) of a video game system according to an embodiment of the present invention.

FIG. 6 is a block diagram of a circuit of a video game system according to an embodiment of the present invention.

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

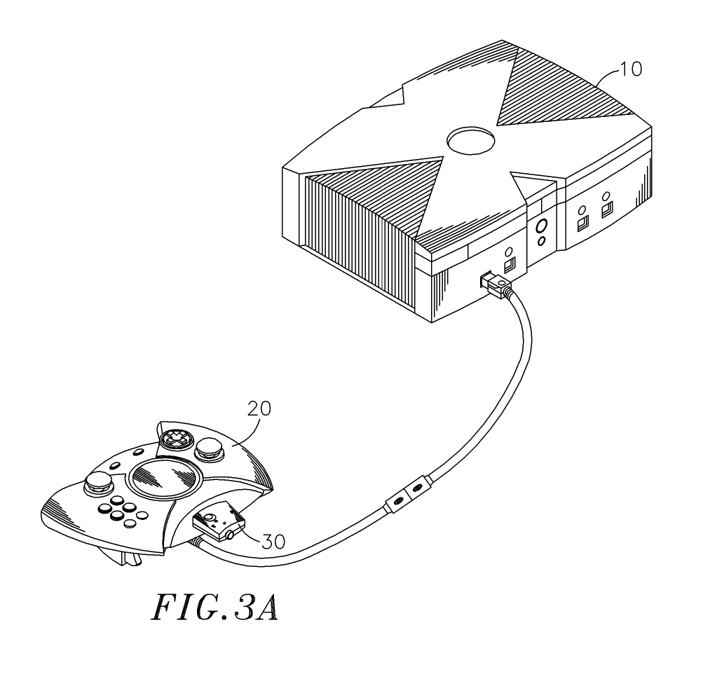

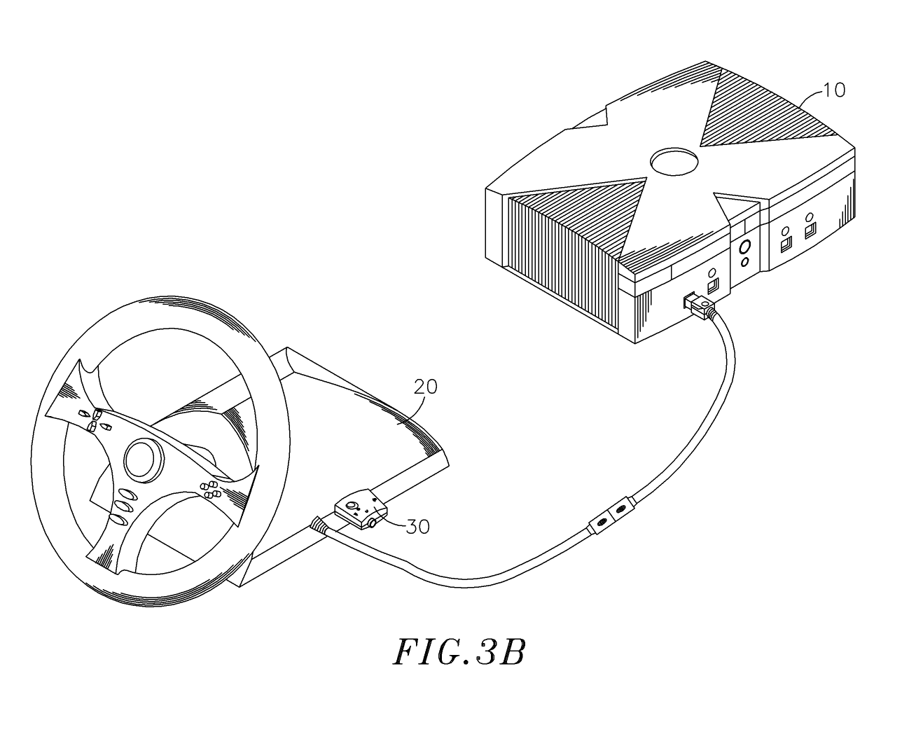

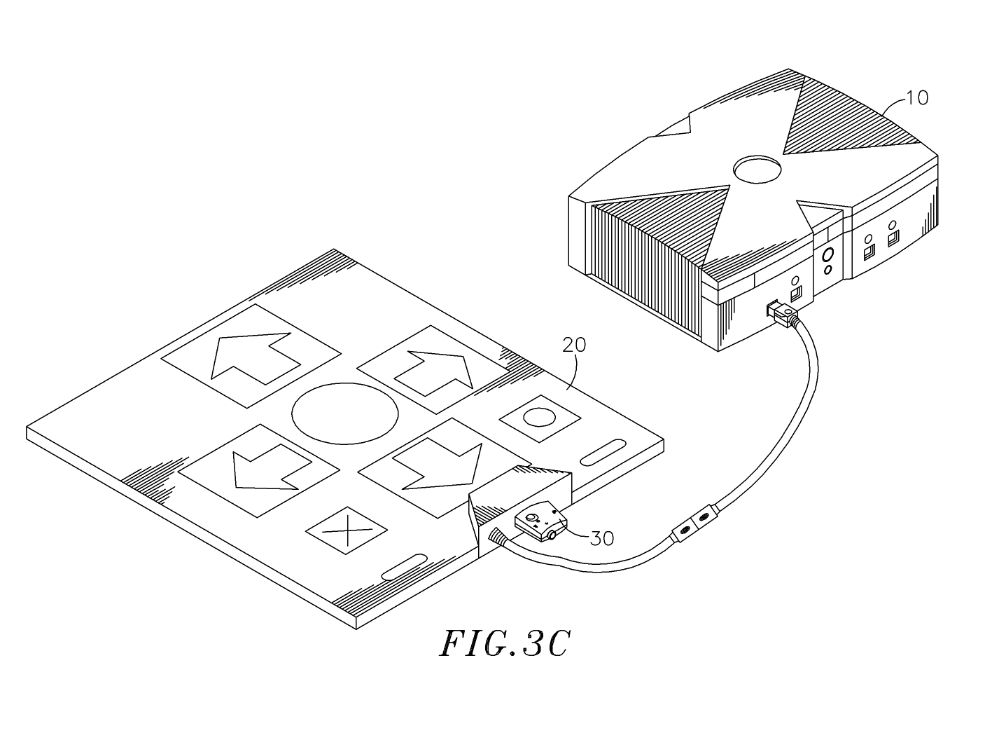

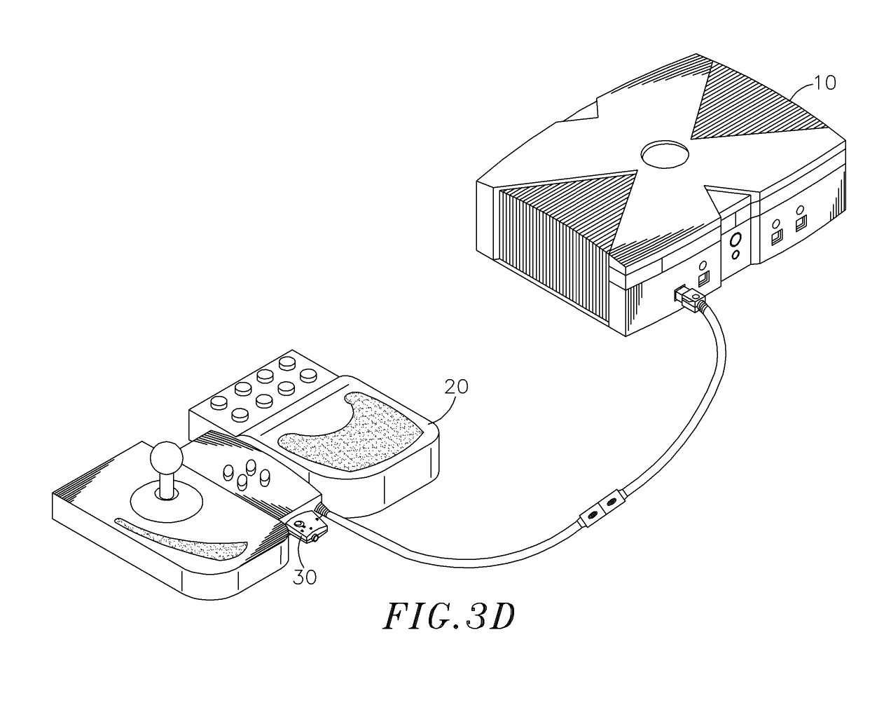

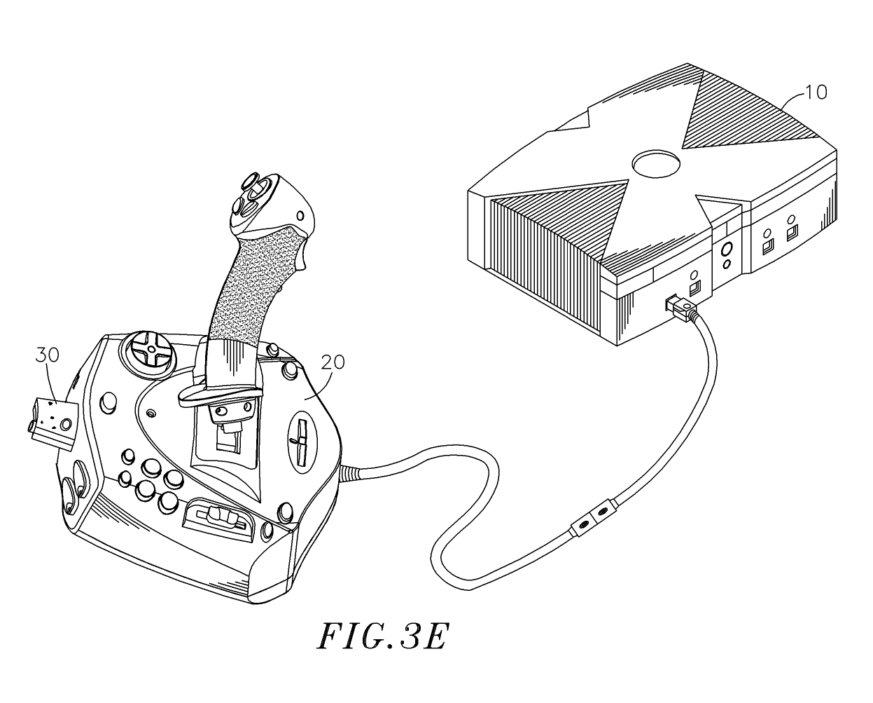

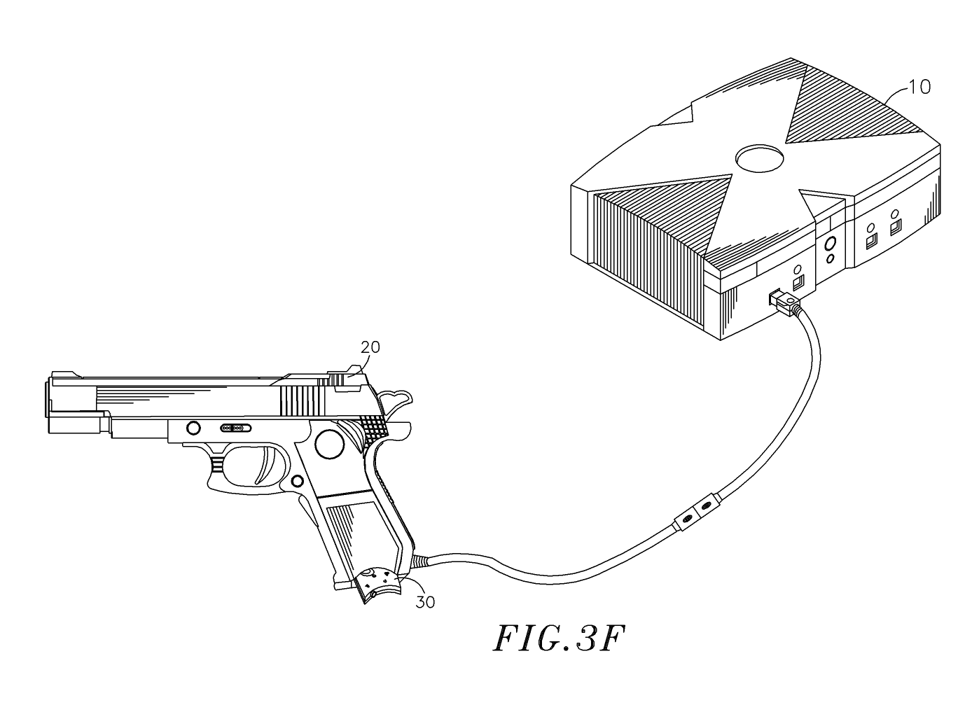

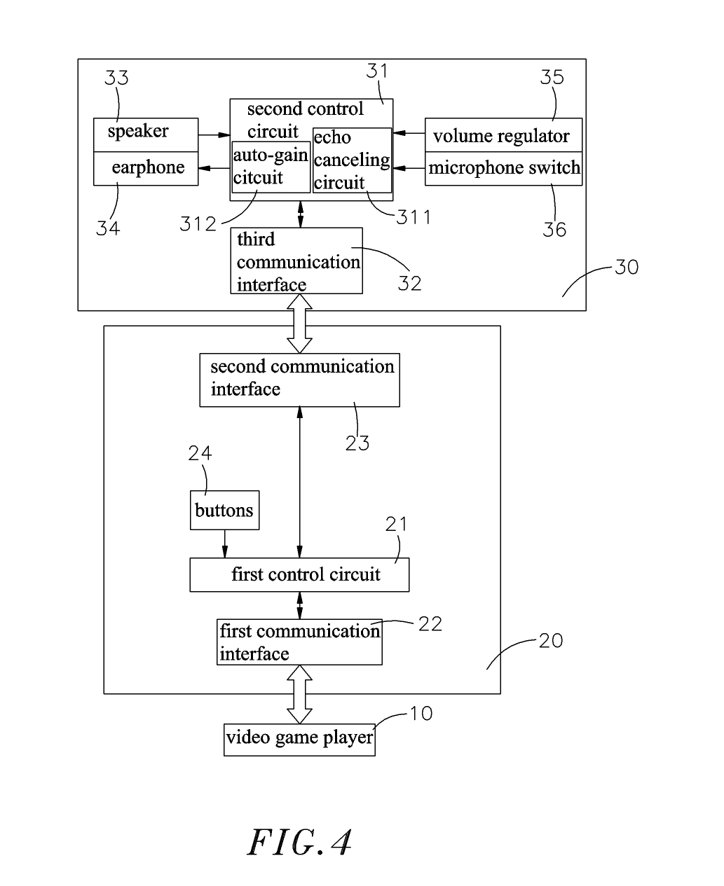

Referring to FIGS. 3A and 4, an elevational view (1) and a block diagram of a circuit, of a video game system according to an embodiment of the present invention are respectively shown. The game controller 20 comprises a first communication interface 22 connected to a video game player 10 and a second communication interface 23 connected to a third communication interface 32 of a sound device 30. The game controller 20 comprises a first control circuit 21, a first communication interface 22, a second communication interface 23 and buttons 24, wherein the first communication interface 22, the second communication interface 23 and buttons 24 are connected to the first control circuit 21. The sound device 30 comprises a second control circuit 31 comprising an echo canceling circuit 311 and an auto-gain circuit 312. The second control circuit 31 is connected to the third communication interface 32, the speaker 33, the microphone 34, the volume regulator 35 and the microphone switch 36.

To assemble the video game system, the game controller 20 is connected into the video game player 10, and the sound device 30 is connected to the game controller 20.

Furthermore, when operating the video game system of the present invention, the signals generated during the game controller 20 for controlling the buttons 24 are transmitted to the video game player 10 via the first control circuit 21 and the first communication interface 22.

The volume regulator 35 is adapted for adjusting the volume of the speaker 33 of the sound device 30, and the microphone switch 36 is adapted for turning on/off the microphone 34. The signal generated during the above adjustment enables the second control circuit 31 to control the volume of the speaker 33 and to turn on/off the microphone 34.

Furthermore, the second control circuit 31 comprises an echo canceling circuit 331 and an auto-gain circuit 312. The echo canceling circuit 311 is adapted for canceling the echo. The auto-gain circuit 312 is adapted for balancing an over loud volume sound or low volume sound.

FIG. 3A-3F are elevational views (1), (2), (3), (4), (5) and (6) according to various embodiments of the present invention, wherein the game controller 20 can be a palm joystick, a steering wheel, a dancing pad, a joystick, a flight joystick or a light beam gun.

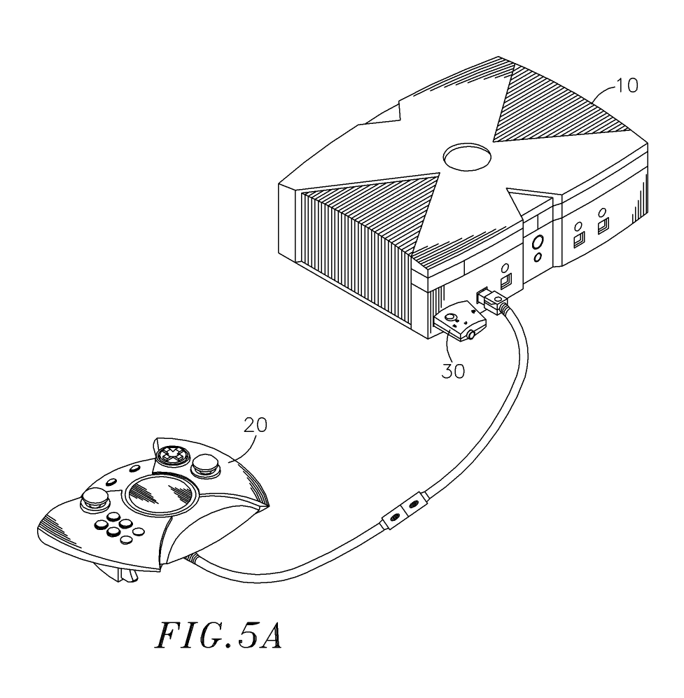

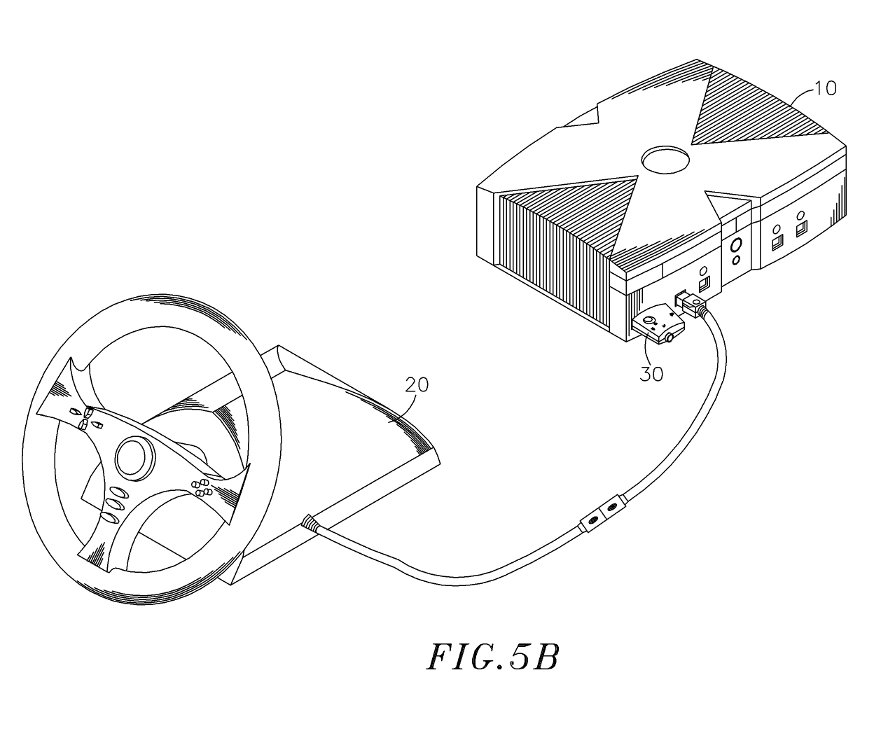

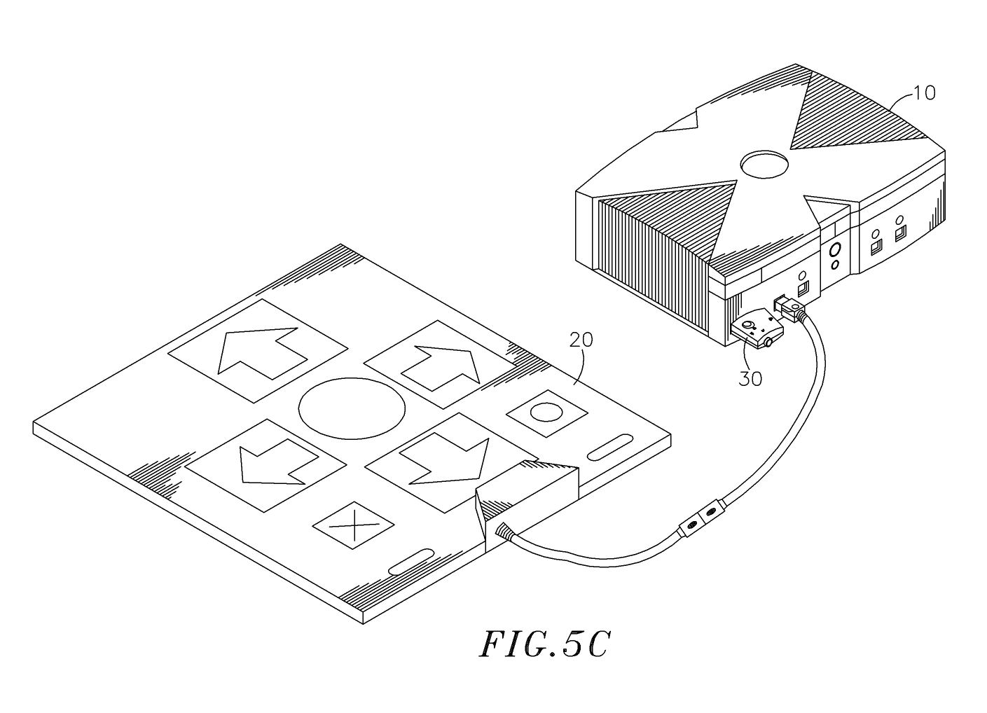

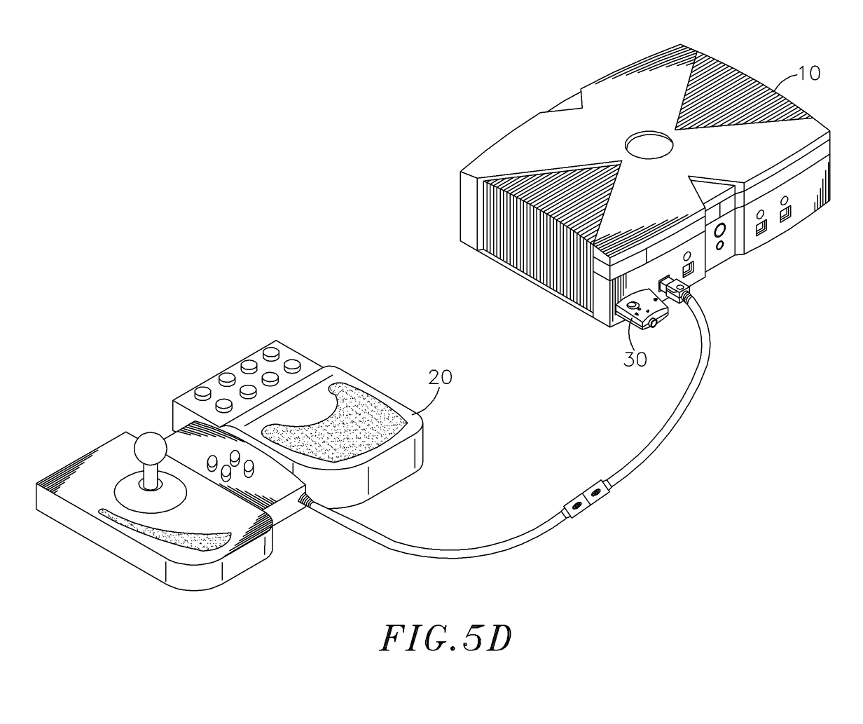

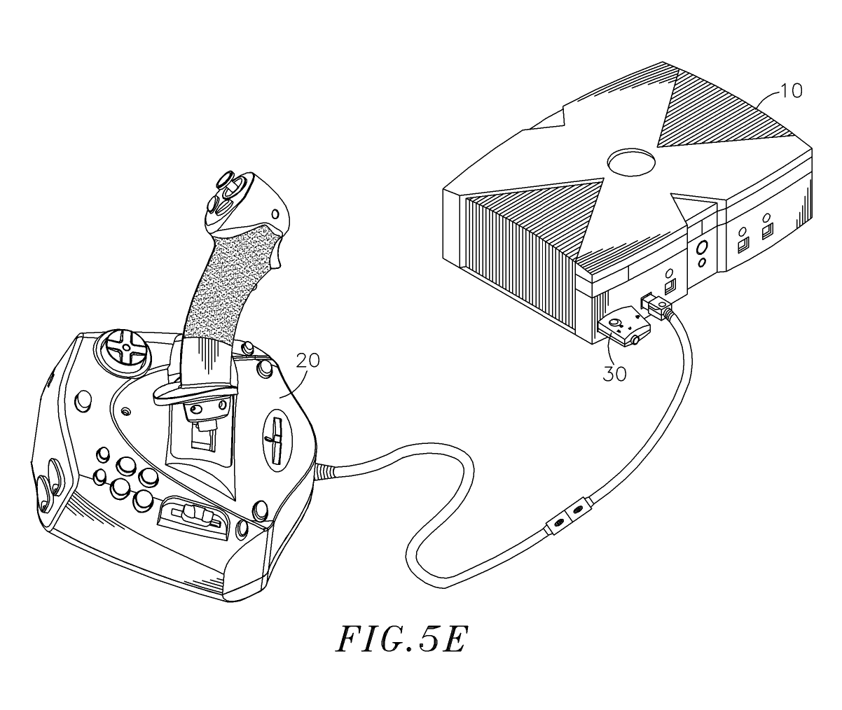

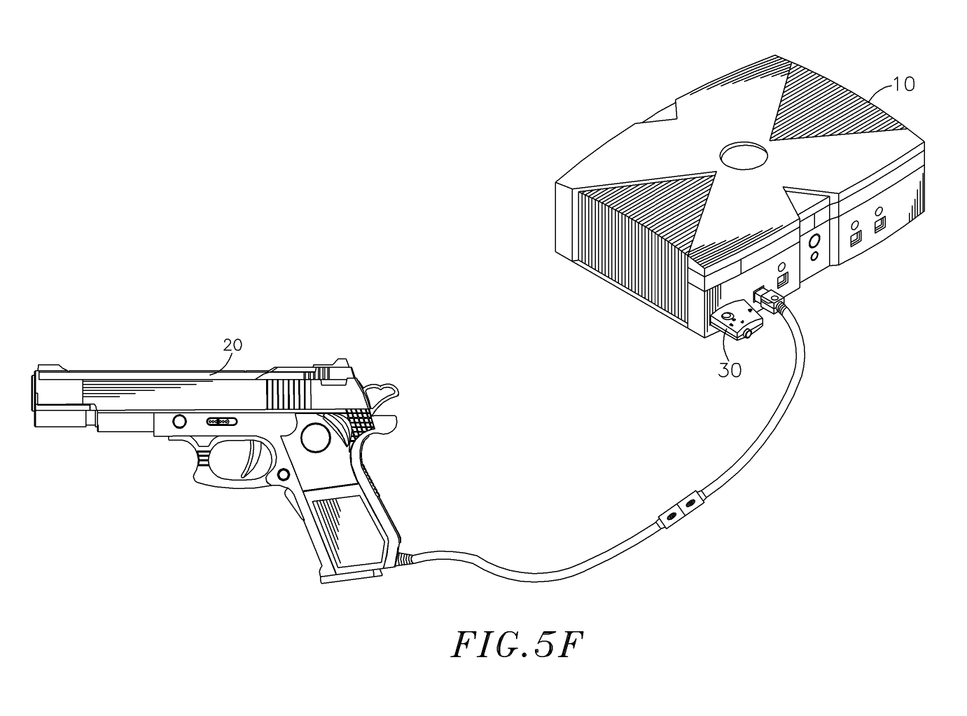

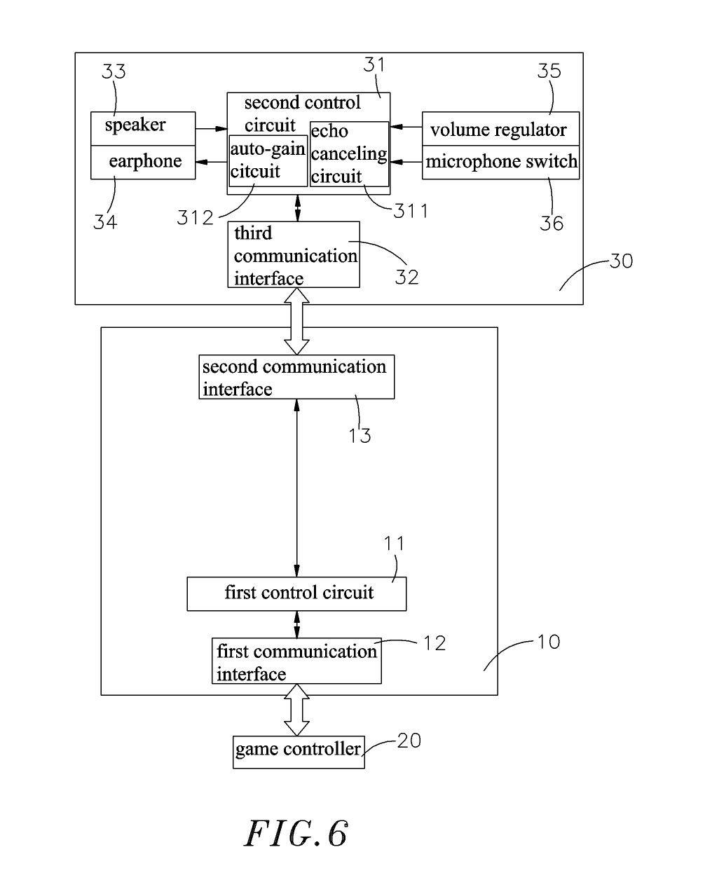

FIGS. 5A and 6 are respectively an elevational view (1) and a block diagram of a circuit of a video game system according an embodiment of the present invention. The first communication interface 12 of the video game player 10 is connected to the game controller 20, and the second communication interface 13 is connected to the third communication interface 32 of the sound device 30. The video game player 10 comprises a first control circuit 11, a first communication interface 12 and a second communication interface 13. The sound device 30 comprises the second control circuit 31 comprising the echo canceling circuit 311 and the auto-gain circuit 312. The second control circuit 31 is connected to the third communication interface 32, the speaker 33, the microphone 34, volume regulator 35 and the microphone switch 36.

To assemble the video game system of this embodiment of the present invention, the video game player 10 is connected to the game controller 20 and the sound device 30 respectively.

According to an embodiment of the present invention, the volume regulator 35 is adapted for adjusting the volume of the speaker 33 of the sound device 30, and the microphone switch 36 is adapted for turning on/off the microphone 34. The signal generated during the above adjustment enables the second control circuit 31 to control the volume of the speaker 33 and to turn on/off the microphone 34.

Furthermore, the second control circuit 31 comprises an echo canceling circuit 331 and an auto-gain circuit 312. The echo canceling circuit 311 is adapted for canceling the echo. The auto-gain circuit 312 is adapted for balancing an over loud volume sound or low volume sound.

Additionally, referring to FIG. 5A-5F, are elevational views (1), (2), (3), (4), (5) and (6) according to various embodiments of the present invention, wherein the game controller 20 can be a palm joystick, a steering wheel, a dancing pad, a joystick, a flight joystick or a light beam gun.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A video game system having sound device, comprising:
a video game player, comprising a game controller, said game controller comprising a first control circuit, a first communication interface and a second communication interface and buttons; and
a sound device, connected to said game controller of said video game player, wherein said sound device comprises a third communication interface and a second control circuit, wherein said first communication interface and said second communication interface of said game controller are respectively connected to said video game player and said third communication interface of said sound device and said second control circuit is connected to said third communication interface, a speaker, a microphone, a volume regulator and a microphone switch, and wherein by operating said volume regulator and said microphone switch, a signal can be generated so that said second control circuit can control the volume of said speaker and turn on/off said microphone, and players can communicate with each other via said speaker and said microphone without wearing a earphones and microphone while playing an online video game.

2. The video game system having sound device according to claim 1, wherein said second control circuit comprises an auto-gain circuit for balancing an over loud volume sound or a low volume sound.

3. The video game system having sound device according to claim 1, wherein said second control circuit comprises an echo canceling circuit for canceling an echo.

4. The video game system having sound device according to claim 1, wherein said game controller is a palm joystick.

5. The video game system having sound device according to claim 1, wherein said game controller is a steering wheel.

6. The video game system having sound device according to claim 1, wherein said game controller is a dancing pad.

7. The video game system having sound device according to claim 1, wherein said game controller is a joystick.

8. The video game system having sound device according to claim 1, wherein said game controller is a flight joystick.

9. The video game system having sound device according to claim 1, wherein said game controller is a light beam gun.

10. A sound device of a video game system, said video game system comprising at least a video game player having a first control circuit, a first communication interface and a second communication interface, said sound devices comprising:
a game controller, connected to said first communication interface;
a third communication interface, connected to said second communication interface; and
a second control circuit, connected to said third communication interface, a speaker, a microphone, a volume regulator and a microphone switch, wherein a signal can be generated by operating said volume regulator and said microphone switch can be used by said second control circuit to control a volume of said speaker and turn on/off said microphone, and players can communicate with each other via said speaker and said microphone without wearing a earphone and microphone while playing online video game.

11. The sound device of a video game system according to claim 10, wherein said second control circuit comprises an auto-gain circuit for balancing an over loud volume sound or a low volume sound.

12. The sound device of a video game system according to claim 10, wherein said second control circuit comprises an echo canceling circuit for canceling an echo.

13. The sound device of a video game system according to claim 10, wherein said game controller is a palm joystick.

14. The sound device of a video game system according to claim 10, wherein said game controller is a steering wheel.

15. The sound device of a video game system according to claim 10, wherein said game controller is a dancing pad.

16. The sound device of a video game system according to claim 10, wherein said game controller is a joystick.

17. The sound device of a video game system according to claim 10, wherein said game controller is a flight joystick.

18. The sound device of a video game system according to claim 10, wherein said game controller is a light beam gun.
